(19) United States
(12) Patent Application Publication
(10) Pub. No.: US 2025/0167647 A1
(43) Pub. Date: May 22, 2025

(54) METHOD FOR CONTROLLING RESIN MOLDING APPARATUS, AND RESIN MOLDING APPARATUS

(71) Applicant: TOYOTA BOSHOKU KABUSHIKI KAISHA, Aichi-ken (JP)

(72) Inventors: Hiroyuki SAIKI, Toki-shi (JP); Yasunori SAKURAI, Hashima-shi (JP); Keita NAMBA, Nagoya-shi (JP)

(73) Assignee: TOYOTA BOSHOKU KABUSHIKI KAISHA, Aichi-ken (JP)

(21) Appl. No.: 18/950,545

(22) Filed: Nov. 18, 2024

(30) Foreign Application Priority Data
Nov. 22, 2023 (JP) 2023-198292

(51) Int. Cl. H02K 15/12; B29C 31/06; B29C 70/68; B29C 70/84; B29L 31/00; H02K 1/276; H02K 1/28; H02K 15/03

(52) U.S. Cl. CPC H02K 15/12; B29C 31/06; B29C 70/681; B29C 70/845; H02K 1/276; H02K 1/28; H02K 15/03; B29L 2031/7498

(57) ABSTRACT

A method for controlling a resin molding apparatus includes causing the resin molding apparatus to execute, as a single molding cycle, a series of steps including a molding step that molds a resin portion using a molding unit and a measuring-holding step that measures a resin material using a measuring-holding unit and holds the resin material subsequent to the molding step. The method also includes controlling operation of the resin molding apparatus such that the measuring-holding unit does not measure or hold the resin material in a final one of molding cycles that are executed repeatedly a predetermined number of times.

### CROSS-REFERENCE TO RELATED APPLICATIONS

This application is based upon and claims the benefit of priority from prior Japanese Patent Application No. 2023-198292, filed on Nov. 22, 2023, the entire contents of which are incorporated herein by reference.

### BACKGROUND

### 1. Field

The present disclosure relates to a method for controlling a resin molding apparatus and to the resin molding apparatus.

### 2. Description of Related Art

Typically, resin portions are molded onto a motor core of a rotating electric machine (see, for example, Japanese Patent No. 4688950). In the publication, with magnets respectively accommodated in magnet accommodating holes of the motor core, resin portions are molded in the gaps between the magnet accommodating holes and the magnets. Each magnet is fixed to the motor core by a corresponding resin portion.

To mold resin portions onto motor cores, a resin molding apparatus such as an injection-molding machine is used, and a series of processes (i.e., a molding cycle) including a loading step, a molding step, and an extraction step is repeatedly executed. In the loading step, the motor cores with the magnets accommodated in the magnet accommodating holes are loaded into the resin molding apparatus. Next, in the molding step, a resin portion is molded into each magnet accommodating hole using the resin molding apparatus. Then, in the extraction step, the motor core is extracted out of the resin molding apparatus.

In such a resin molding apparatus, a measuring-holding step is typically executed after the molding step in the current molding cycle is completed in preparation for use in the molding step of the next molding cycle. In the measuring-holding step, a predetermined amount of measured resin material is held in the resin molding apparatus.

The operation of the resin molding apparatus may be stopped during an operational shutdown or during switching of the object to be molded. In such a case, the predetermined amount of resin material held in the resin molding apparatus during the measuring-holding step remains in the resin molding apparatus.

Thus, the resin material to be used in the molding step may be changed or the amount of resin material used may be changed, as the resin molding apparatus stops operating. This requires a removal task that removes the resin material left in the resin molding apparatus before resuming operation of the resin molding apparatus. In such a case, the operational efficiency of the resin molding apparatus decreases to the extent that such a removal task becomes necessary.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An aspect of the present disclosure provides a method for controlling a resin molding apparatus. The resin molding apparatus includes a measuring-holding unit configured to measure molten resin material and hold a predetermined amount of the measured resin material and a molding unit configured to use the predetermined amount of the resin material held by the measuring-holding unit to mold a resin portion onto an object to be molded, including a motor core. The method for controlling the resin molding apparatus includes causing the resin molding apparatus to execute, as a single molding cycle, a series of steps including a molding step that molds the resin portion using the molding unit a measuring-holding step that measures the resin material using the measuring-holding unit and holds the resin material subsequent to the molding step and controlling operation of the resin molding apparatus such that the measuring-holding unit does not measure or hold the resin material in a final one of molding cycles that are executed repeatedly a predetermined number of times.

An aspect of the present disclosure provides a resin molding apparatus. The resin molding apparatus includes a measuring-holding unit configured to measure molten resin material and hold a predetermined amount of the measured resin material, a molding unit configured to use the predetermined amount of the resin material held by the measuring-holding unit to mold a resin portion onto an object to be molded, including a motor core, and circuitry configured to cause the molding unit and the measuring-holding unit to repeatedly execute a molding cycle during which the molding unit molds the resin portion and the measuring-holding unit operates after molding of the resin portion is completed and prohibit the measuring-holding unit from measuring the resin material and holding the resin material in a final one of molding cycles that are executed repeatedly a predetermined number of times.

Other features and aspects will be apparent from the following detailed description, the drawings, and the claims.

### BRIEF DESCRIPTION OF THE DRAWINGS

FIG. 1 is a plan view of a rotor that is manufactured using a resin molding apparatus according to a first embodiment.

FIG. 2 is a side cross-sectional view of the rotor.

FIG. 3 is a side cross-sectional view of a workpiece, which is an object to be molded, in the resin molding apparatus of the first embodiment.

FIG. 4 is a schematic diagram illustrating the configuration of the resin molding apparatus of the first embodiment.

FIG. 5 is a flowchart illustrating the procedure for controlling the resin molding apparatus of the first embodiment.

FIG. 6 is a timing diagram illustrating changes in the amount of resin material held in the measuring-holding unit during a single molding cycle.

FIG. 7 is a flowchart illustrating the procedure for controlling the resin molding apparatus according to a second embodiment.

FIG. 8 is a timing diagram illustrating changes in the amount of resin material stored in the reservoir.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

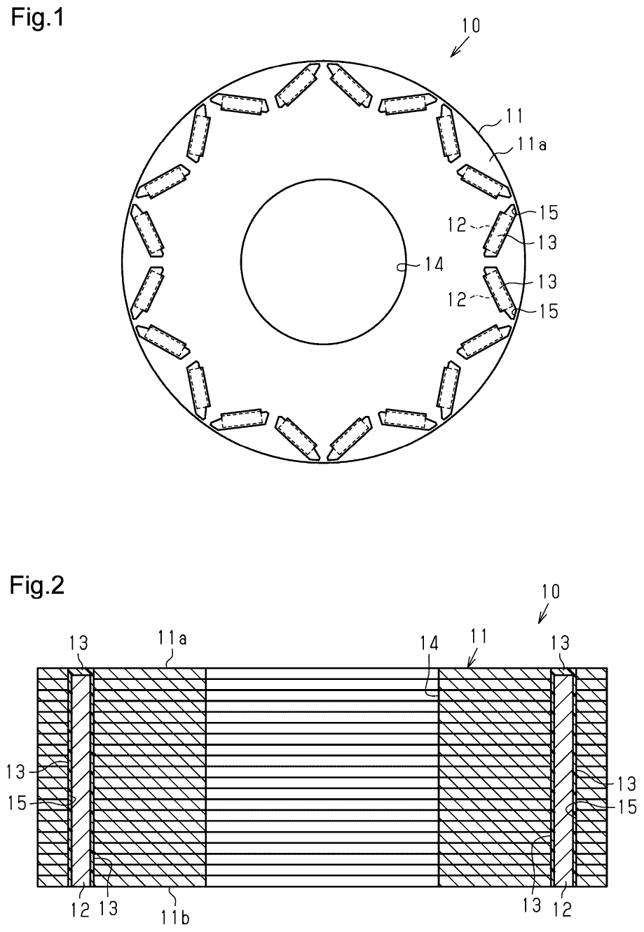

A method for controlling a resin molding apparatus and the resin molding apparatus according to a first embodiment will now be described with reference to FIGS. 1 to 6.

### Rotor 10

First, a rotor manufactured using the method for controlling the resin molding apparatus of the present embodiment and the resin molding apparatus itself will be described.

As shown in FIGS. 1 and 2, the rotor 10 includes a rotor core 11, which serves as a motor core, magnets 12, and resin portions 13. The rotor 10 is, for example, a rotor used for a magnet-embedded motor.

### Rotor Core 11

The rotor core 11 is substantially cylindrical.

As shown in FIG. 2, the rotor core 11 is formed by stacking iron core pieces, which are, for example, punched out of an electrical steel sheet. The rotor core 11 includes a first end face 11a and a second end face 11b, on its opposite sides in the axial direction of the rotor core 11 (hereinafter simply referred to as the axial direction). The rotor core 11 includes a central hole 14 and magnet accommodating holes 15. A shaft (not shown) is inserted into the central hole 14. The magnets 12 are respectively accommodated in the magnet accommodating holes 15. The magnet accommodating holes 15 are arranged at intervals in the circumferential direction of the rotor core 11.

The central hole 14 and the magnet accommodating holes 15 extend through the rotor core 11 in the axial direction. That is, the central hole 14 and the magnet accommodating holes 15 open in the first end face 11a and the second end face 11b. As shown in FIG. 1, each magnet accommodating hole 15 has a substantially rectangular cross-sectional shape that is orthogonal to the axial direction. The rectangular cross-sectional shape includes long sides and short sides. The cross-sectional shape of each magnet accommodating hole 15 is constant over the entire length in the axial direction.

### Magnet 12

Each magnet 12 is accommodated in a corresponding magnet accommodating hole 15. The magnets 12 are fixed to the rotor core 11, with the resin portions 13 filling the magnet accommodating holes 15.

As shown in FIG. 2, each magnet 12 has a shape elongated in the axial direction. Each magnet 12 has a substantially rectangular cross-section that is orthogonal to the axial direction. The cross-sectional shape includes long and short sides.

### Resin Portion 13

The resin portion 13 fills, for example, the entire circumference of the magnet 12 between the inner surface of the magnet accommodating hole 15 and the outer surface of the magnet 12. The resin portion 13 is formed from thermoplastic resin materials, such as liquid crystal polymers.

### Resin Molding Apparatus 20

A resin molding apparatus 20 according to the present embodiment will now be described.

The resin molding apparatus 20 is configured to mold the resin portion 13 onto an object to be molded (hereinafter referred to as the workpiece W), including the rotor core 11.

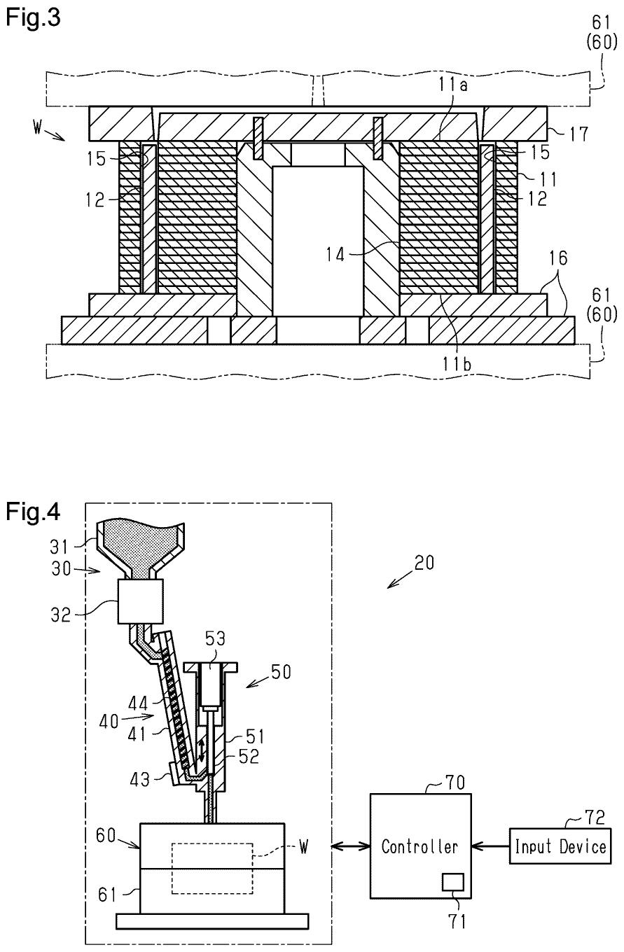

As shown in FIG. 3, the workpiece W includes the rotor core 11 and the magnets 12. Specifically, the workpiece W has each magnet 12 accommodated in a corresponding magnet accommodating hole 15 of the rotor core 11. In the present embodiment, the workpiece W is placed on pallet members 16 and has a gate plate 17 attached to its top before being loaded into the resin molding apparatus 20.

As shown in FIG. 4, the resin molding apparatus 20 includes a supply unit 30, a reservoir 40, a measuring-holding unit 50, a molding unit 60, and a controller 70. In the present embodiment, the resin molding apparatus 20 is an injection-molding machine.

### Supply Unit 30

The supply unit 30 includes a hopper 31 and an opening-closing member 32.

The hopper 31 is configured to store granular resin material. The hopper 31 is connected to the reservoir 40 by the opening-closing member 32. In the present embodiment, when the opening-closing member 32 is opened, the hopper 31 and the reservoir 40 are connected to each other. In this state, the reservoir 40 is supplied with resin material from the hopper 31. When the opening-closing member 32 is closed, the hopper 31 and the reservoir 40 are disconnected from each other. In this state, the hopper 31 stops supplying resin material to the reservoir 40. In the present embodiment, operation of the supply unit 30 (specifically, opening-closing member 32) is controlled to supply the reservoir 40 with resin material from the hopper 31.

### Reservoir 40

The reservoir 40 is configured to melt and store the resin material supplied from the supply unit 30.

The reservoir 40 includes a cylinder 41, a heater 43, and a screw 44.

The cylinder 41 has a tubular shape. One end of the cylinder 41 in the axial direction is connected to the supply unit 30, forming a supply port for granular resin material. The other end of the cylinder part 41 in the axial direction is connected to the measuring-holding unit 50. The cylinder 41 stores resin material. The heater 43 is attached to the outer wall of the cylinder 41. By heating with the heater 43, the resin material in the cylinder 41 is melted and stored in a molten state. The screw 44 is configured to deliver the resin material from the cylinder 41 to the measuring-holding unit 50 (toward the lower side in FIG. 4). In the present embodiment, the resin material in the reservoir 40 corresponds to resin material to be measured by the measuring-holding unit 50.

### Measuring-Holding Unit 50

The measuring-holding unit 50 is configured to measure molten resin material and hold a predetermined amount of the measured resin material.

The measuring-holding unit 50 includes a cylinder 51 connected to the reservoir 40, a plunger 52 configured to reciprocate in the cylinder 51, and an actuator 53 that reciprocates the plunger 52.

In the present embodiment, when the measuring-holding unit 50 measures and holds resin material, operation of the actuator 53 is controlled to move the plunger 52 in a direction that expands the space in the cylinder 51 (in the upward direction in FIG. 4). As a result, the molten resin material in the reservoir 40 is drawn into the cylinder 51.

In the present embodiment, the movement amount of the plunger 52 is set according to the specifications of the current workpiece W, which is an object to be molded. Specifically, the movement amount of the plunger 52 is set such that a predetermined amount V of resin material is drawn into and held by the cylinder 51 of the measuring-holding unit 50. The predetermined amount V is used to mold the resin portion 13 for one workpiece W.

In the present embodiment, molten resin material is measured by the measuring-holding unit 50 and the predetermined amount V of the measured resin material is held in the measuring-holding unit 50.

In the present embodiment, when the resin portion 13 is molded onto the workpiece W, the plunger 52 is moved in a direction that narrows the space in the cylinder 51 (downward in FIG. 4) through the operation control of the actuator 53. As a result, the predetermined amount V of resin material held in the cylinder 51 is injected into the workpiece W.

### Molding Unit 60

The molding unit 60 is configured to mold the resin portion 13 onto the workpiece W using the predetermined amount V of resin material held in the measuring-holding unit 50.

The molding unit 60 includes a mold 61 and a drive device (not shown). The mold 61 is used to mold the resin portion 13. The drive device selectively opens and closes the mold 61. In the present embodiment, the mold 61 is replaceable according to the specifications of the workpiece W, which is an object to be molded. When switching the workpiece W, the mold 61 is replaced with one that matches the specifications of the new workpiece W.

### Controller 70

The controller 70 may be, for example, a micro-control unit. That is, the controller 70 may be circuitry including: 1) one or more processors that operate according to a computer program (software); 2) one or more dedicated hardware circuits such as application-specific integrated circuits (ASICs) that execute at least part of various processes; or 3) a combination thereof. The processor includes a CPU and a memory such as a RAM and a ROM. The memory stores program codes or commands configured to cause the CPU to execute processes. The memory, or a computer-readable medium, includes any type of media that are accessible by general-purpose computers and dedicated computers. In the present embodiment, the controller 70 includes a processor and a memory 71. The memory 71 includes a read-only memory (ROM) and a random-access memory (RAM). The memory 71 stores programs and data for control.

The controller 70 stores various types of information related to the processing of the workpiece W. The controller 70 is connected to an input device 72. The input device 72 is operated so that the controller 70 receives various types of information related to the processing of the workpiece W. The information includes that related to the predetermined amount V and the number of workpieces W that will be processed (hereinafter referred to as the planned processing quantity). Further, the controller 70 counts and stores the number of workpieces W that have been processed.

The controller 70 is connected to the supply unit 30, the reservoir 40, the measuring-holding unit 50, and the molding unit 60. The controller 70 performs various calculations based on various types of information related to the processing of the workpiece W. Based on the calculation results, the controller 70 controls operation of the components of the resin molding apparatus 20 (i.e., the supply unit 30, the reservoir 40, the measuring-holding unit 50, and the molding unit 60).

### Method for Controlling Resin Molding Apparatus 20

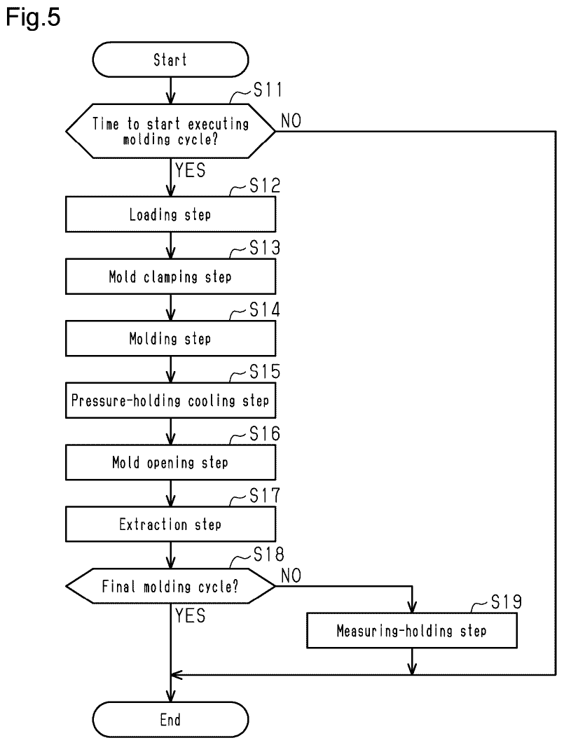

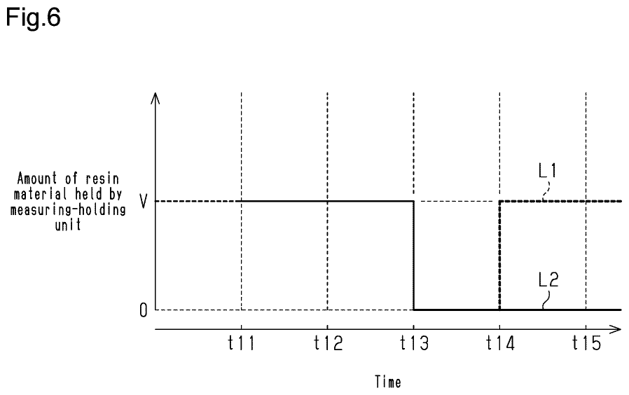

The method for controlling the resin molding apparatus 20 will now be described with reference to FIGS. 5 and 6.

FIG. 5 illustrates the procedure for executing processes related to the control of operation of the resin molding apparatus 20 (operation control process). The series of processes shown in the flowchart of FIG. 5 schematically illustrates the procedure for executing the operation control process. Actual processes are performed by the controller 70 as processes at predetermined intervals.

As shown in FIG. 5, in this process, it is first determined whether the time to start executing the molding cycle has been reached (step S11). In a case in which the time to start executing the molding cycle has not been reached (step S11: NO), the current process is ended without executing the following processes (steps S12 to S19).

In a case in which the time to start executing the molding cycle has been reached (step S11: YES), the processes of steps S12 to S19 are executed.

First, a loading step is executed (step S12). In the loading step, the operation control of a loading device (not shown) is performed to load the workpiece W into the mold 61 in an open state.

After the loading step, a mold clamping step is executed (step S13). In the mold clamping step, the operation control of the drive device is performed to clamp the mold 61.

After the mold clamping step, a molding step is executed (step S14). In the molding step, the operation control of the drive device is performed to hold the mold 61 in a clamped state. Further, the operation control of the actuator 53 is performed to inject the predetermined amount V of the resin material into the workpiece W. As a result, the resin portion 13 is molded onto the workpiece W.

After the molding step, a pressure-holding cooling step is executed (step S15). In the pressure-holding cooling step, the operation control of the drive device is performed to keep the mold 61 clamped for a predetermined period. This allows the resin portion 13 to adequately cure inside the magnet accommodating hole 15.

After the pressure-holding cooling step, a mold opening step is executed (step S16). In the mold opening step, the operation control of the drive device is performed to open the mold 61.

After the mold opening step, an extraction step is executed (step S17). In the extraction step, the operation control of the loading device (not shown) is performed to extract the workpiece W out of the mold 61 in an open state.

After the pressure-holding cooling step, in a period Tl until the final one of multiple molding cycles that are repeatedly executed a predetermined number of times (step S18: NO), a measuring-holding step is performed (step S19). In the present embodiment, the predetermined number of times is set to correspond to the planned processing quantity. For example, when the planned processing quantity is 200, the predetermined number of times is set to 200.

In the measuring-holding step, the operation control of the measuring-holding unit 50 (specifically, the actuator 53) is performed so that the predetermined amount V of molten resin material in the reservoir 40 is drawn into and held in the cylinder 51 of the measuring-holding unit 50.

During the period T1, once the measuring-holding step is completed, the current process is ended. In other words, the execution of the current molding cycle is completed.

In the final one of the molding cycles that are repeatedly executed the predetermined number of times (step S18: YES), the current process is ended without executing the measuring-holding step (i.e., without performing the process of step S19). That is, in the present embodiment, in the final molding cycle, the execution of the current molding cycle is completed without executing the measuring-holding step.

### Operation of Present Embodiment

The operation of the present embodiment will now be described.

FIG. 6 illustrates changes in the amount of resin material held in the measuring-holding unit 50 during a single molding cycle.

As shown in FIG. 6, during the period T1, until the final molding cycle, the following steps are conducted in each molding cycle: the loading step (time t11), the mold clamping step (time t12), the molding step (time t13), and the pressure-holding cooling step (time t13 to t14). Further, during the period T1, after the pressure-holding cooling step, the mold opening step and the measuring-holding step (time t14), as well as the extraction step (time t15), are executed.

Thus, during the period T1, as indicated by the broken line LI in FIG. 6, after the completion of the extraction step, i.e., after the completion of each molding cycle (from time t15 onwards), the predetermined amount V of resin material is held in the cylinder 51 of the measuring-holding unit 50. In the next molding cycle, the molding step (time t13) is executed using the predetermined amount V of the resin material held in the measuring-holding unit 50.

In the final molding cycle, the following steps are executed in the same manner as the period T1: the loading step (time t11), the mold clamping step (time t12), the molding step (time t13), the pressure-holding cooling step (time t13 to t14), the mold opening step (time t14), and the extraction step (time t15).

In the final molding cycle, unlike the period T1, the measuring-holding step is not executed. In other words, in the final molding cycle, the measuring-holding unit 50 is prohibited from measuring and holding resin material.

Thus, in the final molding cycle, as indicated by the solid line L2 in FIG. 6, after the completion of the extraction step, i.e., after the completion of the molding cycle (from time t15 onwards), the resin material is not held in the cylinder 51 of the measuring-holding unit 50. In the present embodiment, when the final molding cycle is completed, i.e., when the operation of the resin molding apparatus 20 is stopped, no resin material remains in the resin molding apparatus 20 (specifically, the cylinder 51 of the measuring-holding unit 50).

When the operation of the resin molding apparatus 20 is stopped, the workpiece W may be switched. Further, due to the switching of the workpiece W, the amount of resin material used in one molding cycle, i.e., the amount of resin material held in the cylinder 51, may be changed. In this case, if the resin material remains in the cylinder 51 when the operation of the resin molding apparatus 20 is stopped, a removal task needs to be performed to remove the resin material from the cylinder 51 in order to change the amount of resin material held in the cylinder 51.

In the present embodiment, when the operation of the resin molding apparatus 20 is stopped, no resin material remains in the cylinder 51. Thus, even when the amount of resin material used is changed due to the switching of the workpiece W, the resin material does not need to be removed from the cylinder 51 for the change. Accordingly, the reduction in the operational efficiency of the resin molding apparatus 20 is limited to the extent that the removal task is no longer necessary.

Additionally, due to the switching of the workpiece W when the resin molding apparatus 20 is stopped, the type of resin material used in the resin molding apparatus 20 may be changed. In this case, changing the type of resin material used requires the removal of the resin material left in the reservoir 40 and the measuring-holding unit 50.

In the present embodiment, when the resin molding apparatus 20 is stopped, no resin material remains at least in the cylinder 51. Thus, when the type of resin material is changed due to the switching of the workpiece W, resin material does not need to be removed from the cylinder 51 although resin material needs to be removed from the reservoir 40. In this case, the time required to remove the resin material from the resin molding apparatus 20 is shortened to the extent that the task of removing the resin material from within the cylinder 51 is no longer necessary. As a result, a decrease in the operational efficiency of the resin molding apparatus 20 is limited.

### Operation and Advantages of Present Embodiment

The operation and advantages of the present embodiment will now be described.

(1-1) The resin molding apparatus 20 includes the measuring-holding unit 50 and the molding unit 60. The measuring-holding unit 50 measures molten resin material and holds the predetermined amount V of the measured resin material. The molding unit 60 uses the predetermined amount V of the resin material held in the measuring-holding unit 50 to mold the resin portion 13 onto the workpiece W, including the rotor core 11. The method for controlling the resin molding apparatus 20 includes causing the resin molding apparatus 20 to execute, as a single molding cycle, a series of steps including the molding step and the measuring-holding step. In the molding step, the resin portion 13 is molded using the molding unit 60. In the measuring-holding step, resin material is measured and held using the measuring-holding unit 50 subsequent to the molding step. The method for controlling the resin molding apparatus 20 further includes controlling operation of the resin molding apparatus 20 such that the measuring-holding unit 50 does not measure or hold the resin material in the final one of molding cycles that are executed repeatedly the predetermined number of times.

In the present embodiment, when the resin molding apparatus 20 is stopped, no resin material remains in the measuring-holding unit 50 of the resin molding apparatus 20. This eliminates the need for the removal task to remove the resin material left in the measuring-holding unit 50 before resuming operation of the resin molding apparatus 20. As a result, the reduction in the operational efficiency of the resin molding apparatus 20 is limited to the extent that such a removal task becomes unnecessary.

(1-2) The measuring-holding unit 50 does not measure or hold resin material in the final one of the molding cycles when the workpiece W is switched in an inactive period of the resin molding apparatus 20 subsequent to the final molding cycle.

Thus, even when the amount of resin material used or the type of the resin material is changed due to the switching of the workpiece W, there is no need to remove the resin material from the cylinder 51 for that change. Accordingly, the reduction in the operational efficiency of the resin molding apparatus 20 is limited to the extent that the removal task is no longer necessary.

### Second Embodiment

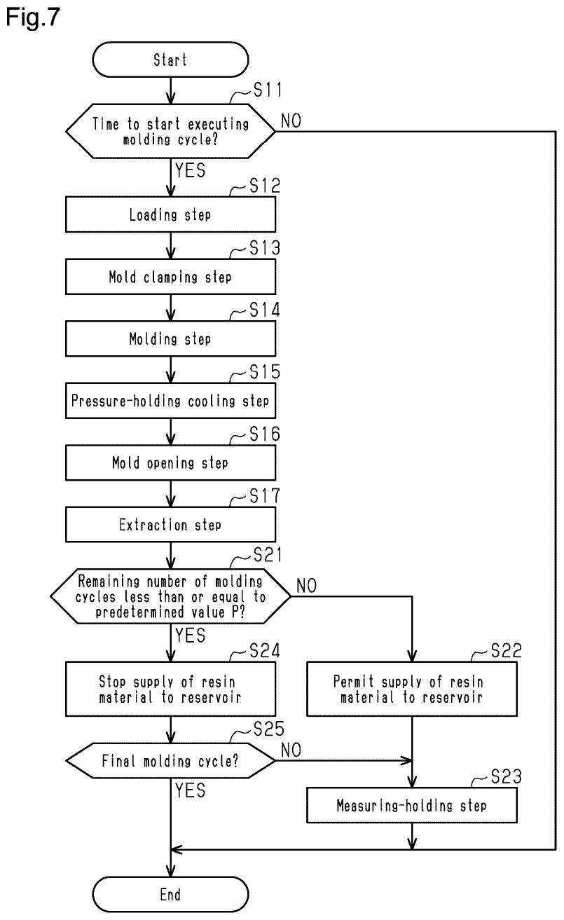

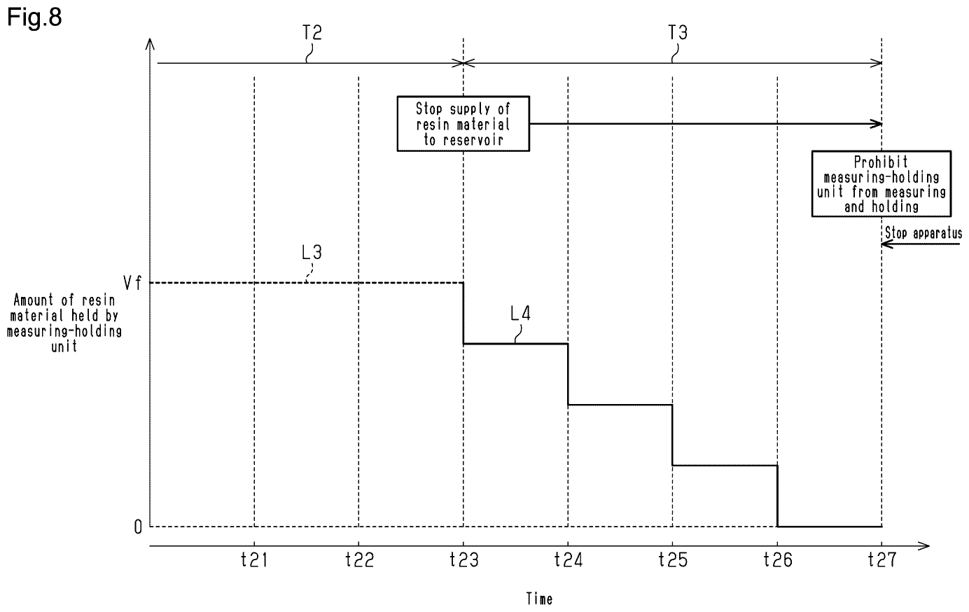

The method for controlling the resin molding apparatus and the resin molding apparatus according to a second embodiment will now be described with reference to FIGS. 7 and 8. Differences from the first embodiment will mainly be discussed. The same or corresponding components as those in the first embodiment are given the same reference numerals, and detailed explanations are omitted.

The present embodiment is different from the first embodiment in the procedure for executing the operation control process. The operation control process according to the present embodiment will now be described.

### Operation Control Process

FIG. 7 illustrates the procedure for executing the operation control process according to the present embodiment. The series of processes shown in the flowchart of FIG. 7 schematically illustrates the procedure for executing the operation control process. Actual processes are performed by the controller 70 as processes at predetermined intervals.

As shown in FIG. 7, in this process, in a case in which the time to start executing the molding cycle has been reached (step S11: YES), the processes of steps S12 to S17 and S21 to S25 are executed.

In this case, the loading step (step S12), the mold clamping step (step S13), the molding step (step S14), the pressure-holding cooling step (step S15), the mold opening step (step S16), and the extraction step (step S17) are sequentially executed.

In this case, out of a period during which the molding cycle is repeatedly executed a predetermined number of times, during a period T2 until the remaining number of molding cycles reaches a predetermined value P (e.g., 5) (step S21: NO), the processes of steps S22 and S23 are executed. The period T2, for instance, is the duration in which the 1st through 195th molding cycles are executed when the predetermined number of times (the planned processing quantity) is set to 200.

In the period T2, after the pressure-holding cooling step, a process is executed to permit the supply of resin material from the supply unit 30 to the reservoir 40 with the execution of the mold opening step and the extraction step (step S22). In the process of step S22, specifically, the opening-closing member 32 is opened or continues to be opened.

Additionally, in the period T2, after the pressure-holding cooling step, the measuring-holding step is executed with the execution of the mold opening step and the extraction step (step S23). In the measuring-holding step, the operation control of the measuring-holding unit 50 (specifically, the actuator 53) is performed so that the predetermined amount V of molten resin material in the reservoir 40 is drawn into and held in the cylinder 51 of the measuring-holding unit 50.

Then, in the period T2, once the measuring-holding step is completed, the current process is ended. In other words, the execution of the current molding cycle is completed.

In a period T3 during which the remaining number of molding cycles becomes less than or equal to the predetermined value P (step S21: YES), after the pressure-holding cooling step, a process is executed to stop supplying resin material from the supply unit 30 to the reservoir 40 with the execution of the mold opening step and the extraction step (step S24). In the process of step S24, specifically, the opening-closing member 32 is closed or continues to be closed.

In the period T3, in a case in which the final molding cycle has not been reached (step S25: NO), after the pressure-holding cooling step, the measuring-holding step is executed with the execution of the mold opening step and the extraction step (step S23).

In this case, once the measuring-holding step is completed, the current process is ended. In other words, the execution of the current molding cycle is completed.

In the period T3, in a case in which the final molding cycle has been reached (step S25: YES), the current process is ended without executing the measuring-holding step. Thus, in the present embodiment, in the final molding cycle, the measuring-holding step is not executed.

In a case in which the time to start executing the molding cycle has not been reached (step S11: NO), the current process is ended without executing the above-described processes (steps S12 to S17 and S21 to S25).

### Operation of Present Embodiment

The operation of the present embodiment will now be described.

FIG. 8 illustrates changes in the amount of resin material stored in the reservoir 40.

Referring to FIG. 8, in the period T2, until the remaining number of molding cycles reaches the predetermined value P, the measuring-holding step is executed in a state in which the supply of resin material from the supply unit 30 to the reservoir 40 is permitted in each molding cycle (times t21, t22).

Thus, in the period T2, as indicated by the broken line L3 in FIG. 8, the resin material is kept in the reservoir 40 by an amount equivalent to its volume (hereinafter referred to as the equivalent amount Vf). In the present embodiment, the equivalent amount Vf is equal to the amount obtained by multiplying the predetermined value P by the predetermined amount V for one of various types of workpieces W (i.e., a specific workpiece W) (Vf=V×P).

Subsequently, when the remaining number of molding cycles reaches the predetermined value P (time t23), the supply of resin material from the supply unit 30 to the reservoir 40 is stopped. Then, in that state, the measuring-holding step is executed. Thus, as shown by the solid line L4 in FIG. 8, the amount of resin material accumulated in the reservoir 40, i.e., the remaining amount of resin material in the reservoir 40, decreases by the predetermined amount V, which is the amount of resin material measured and held by the measuring-holding unit 50.

Subsequently, each time the molding cycle is executed (times t24, t25, t26), the remaining amount of resin material in the reservoir 40 decreases by the predetermined amount V.

In the example shown in FIG. 8, during the execution of the penultimate molding cycle (time t26), the remaining amount of resin material in the reservoir 40 becomes 0. As a result, even during the execution of the final molding cycle (time t27), the remaining amount of resin material in the reservoir 40 becomes 0.

In the final molding cycle (time t27), the molding step is executed using the predetermined amount V of the resin material held in the measuring-holding unit 50 in the immediately preceding molding cycle. This causes the amount of resin material held in the measuring-holding unit 50 to reach 0. In the present embodiment, during the final molding cycle, the measuring-holding step is not executed. Specifically, a process that moves the plunger 52 in a direction that reduces the space in the cylinder 51 is not executed.

In the present embodiment, the supply unit 30 stops supplying resin material to the reservoir 40 at the time when the resin material stored in the reservoir 40 and the resin material held in the measuring-holding unit 50 are almost completely used by executing the molding step in the final molding cycle (time t23).

In the present embodiment, when the execution of the final molding cycle is completed, i.e., when the operation of the resin molding apparatus 20 is stopped, no resin material remains in the resin molding apparatus 20 (specifically, in the cylinder 41 of the reservoir 40 or the cylinder 51 of the measuring-holding unit 50).

Due to the switching of the workpiece W when the operation of the resin molding apparatus 20 is stopped, the amount of resin material used in one molding cycle, i.e., the amount of resin material held in the cylinder 51, may be changed. Additionally, due to the switching of the workpiece W when the resin molding apparatus 20 is stopped, the type of resin material used in the resin molding apparatus 20 may be changed. In both cases, if resin material remains in the resin molding apparatus 20 when its operation is stopped, a removal task of removing the resin material from the resin molding apparatus 20 needs to be performed in order to change the amount or type of the resin material held during the inactive period.

In the present embodiment, when the operation of the resin molding apparatus 20 is stopped, almost no resin material remains in the cylinder 41 of the reservoir 40 or the cylinder 51 of the measuring-holding unit 50. Thus, even when the amount of resin material used or the type of the resin material is changed due to the switching of the workpiece W, the task of removing resin material from the resin molding apparatus 20 for that change is unnecessary or is completed in a shorter period of time. Accordingly, the reduction in the operational efficiency of the resin molding apparatus 20 is limited to the extent that the time required for the removal work is shortened. As a result, the production efficiency of the rotor 10 is improved.

If an operational shutdown causes the resin molding apparatus 20 to stop operating and resin material remains in the resin molding apparatus 20, there is a risk that the resin material left in the resin molding apparatus 20 may degrade during the subsequent inactive period. In such a case, for the resin molding apparatus 20 to run in a proper state for the start of operations, the removal task needs to be performed to remove the resin material from the resin molding apparatus 20 before resuming operation of the resin molding apparatus 20.

In the present embodiment, when the operation of the resin molding apparatus 20 is stopped, almost no resin material remains in the cylinder 41 of the reservoir 40 or the cylinder 51 of the measuring-holding unit 50. Thus, although resin material may degrade during the inactive period of the resin molding apparatus 20, almost no resin material remains in the resin molding apparatus 20. Consequently, the task of removing the resin material is unnecessary or is completed in a shorter period of time.

Accordingly, in the present embodiment, even when the operation of the resin molding apparatus 20 is stopped due to an operational shutdown, the time required to set up the resin molding apparatus 20 is shortened to the extent that the time required for the task of removing resin material is reduced. This limits a decrease in the operational efficiency of the resin molding apparatus 20, thereby improving the operational efficiency of the rotor 10.

### Operation and Advantages of Present Embodiment

The operation and advantages of the present embodiment will now be described.

(2-1) The present embodiment achieves the same advantages as those described in the above-described items (1-1) and (1-2).

(2-2) The resin molding apparatus 20 includes the reservoir 40 and the supply unit 30. The reservoir 40 is connected to the measuring-holding unit 50. The reservoir 40 melts and stores the resin material to be measured by the measuring-holding unit 50. The supply unit 30 supplies the resin material to the reservoir 40. The resin molding apparatus 20 causes the supply unit 30 to stop supplying the resin material to the reservoir 40 at the time when the resin material stored in the reservoir 40 and the resin material held in the measuring-holding unit 50 are almost completely used by executing the molding step in the final molding cycle.

In the present embodiment, the resin molding apparatus 20 with the reservoir 40, which stores the resin material to be measured, ensures that almost no resin material remains in the reservoir 40 or the measuring-holding unit 50 when the operation of the resin molding apparatus 20 is stopped. Accordingly, the removal task, which is performed to remove the resin material from the reservoir 40 or the measuring-holding unit 50 before resuming operation of the resin molding apparatus 20, does not need to be performed or is completed in a shorter period of time. Thus, the decrease in the operational efficiency of the resin molding apparatus 20 is limited to the extent that the time required for the task of removing resin material is reduced.

### Modifications

The above-described embodiments may be modified as follows. The above-described embodiments and the following modifications may be implemented in combination with each other as long as a technical contradiction does not occur.

In the second embodiment, instead of executing the process of closing the opening-closing 32 to stop the supply of resin material from the supply unit 30 to the reservoir 40, a process of stopping the supply of resin material to the hopper 31 may be executed. Examples of the process of stopping the supply of resin material to the hopper 31 includes a process of stopping operation of a supply device that supplies resin material to the hopper 31 when the resin molding apparatus 20 includes the supply device.

Even such a configuration stops supplying resin material to the reservoir 40 at the time when the resin material stored in the reservoir 40 and the resin material held in the measuring-holding unit 50 are almost completely used by executing the molding step in the final molding cycle. In this case, the opening-closing member 32 may be omitted.

In the final molding cycle of the second embodiment, operation of the actuator 53 may be controlled such that the plunger 52 moves in a direction that increases the space in the cylinder 51. During the execution of the final molding cycle, almost no resin material remains in the reservoir 40. Thus, the measuring-holding unit 50, which executed the operation control of the actuator 53 in the final molding cycle, will not measure resin material or hold the measured resin material. That is, even in this case, the measuring-holding unit 50 is prohibited from measuring and holding the resin material.

In the second embodiment, the relationship between the volume (equivalent amount Vf) of the resin material in the reservoir 40 and the predetermined value P may be changed.

For example, if the amount (predetermined amount V) of resin material used per molding cycle is identical in multiple types of workpieces W, then the equivalent amount Vf only needs to be set to the amount obtained by multiplying the predetermined amount V by the predetermined value P (Vf=V×P). In this case, regardless of which workpiece W is selected as an object to be molded, the resin material stored in the reservoir 40 and the resin material held in the measuring-holding unit 50 are almost completely used by executing the molding step in the final molding cycle.

Additionally, if the amount (predetermined amount V) of resin material used per molding cycle is different between multiple types of workpieces W, then the equivalent amount Vf and the predetermined value P may be set as follows. Regardless of which workpiece W is selected as an object to be molded, the equivalent amount Vf and the predetermined value P may be such that the amount of resin material left in the reservoir 40 becomes 0 or becomes a minimal amount when the operation of the resin molding apparatus 20 is stopped.

The method for controlling the resin molding apparatus and the resin molding apparatus according to each of the above-described embodiments may also be employed in a resin molding apparatus that molds a resin portion onto an object to be molded, including a stator core. Examples of such a resin molding apparatus include a resin molding apparatus that molds a resin portion between the stator core and a winding.

The method for controlling the resin molding apparatus and the resin molding apparatus according to each of the above-described embodiments may also be employed in a resin molding apparatus that molds a resin portion formed from adhesive, which serves as resin material, onto an object to be molded, including a motor core. Examples of such a resin molding apparatus include a resin molding apparatus used for molding a resin portion to bond electrical steel sheets included in the motor core to an object to be molded, which is formed by laminating the electrical steel sheets.

The method for controlling the resin molding apparatus and the resin molding apparatus according to the above-described embodiments may also be employed in a in-line screw resin molding apparatus, in which the screw 44 of the reservoir 40 and the cylinder 51 of the measuring-holding unit 50 are arranged coaxially.

The method for controlling the resin molding apparatus and the resin molding apparatus according to each of the above-described embodiments may also be employed in a resin molding apparatus that uses thermosetting resin material.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included.

1. A method for controlling a resin molding apparatus, wherein
the resin molding apparatus includes:
a measuring-holding unit configured to measure molten resin material and hold a predetermined amount of the measured resin material; and
a molding unit configured to use the predetermined amount of the resin material held by the measuring-holding unit to mold a resin portion onto an object to be molded, including a motor core, wherein
the method for controlling the resin molding apparatus comprises:
causing the resin molding apparatus to execute, as a single molding cycle, a series of steps including a molding step and a measuring-holding step, the molding step molding the resin portion using the molding unit, and the measuring-holding step measuring the resin material using the measuring-holding unit and holding the resin material subsequent to the molding step; and
controlling operation of the resin molding apparatus such that the measuring-holding unit does not measure or hold the resin material in a final one of molding cycles that are executed repeatedly a predetermined number of times.

2. The method for controlling the resin molding apparatus according to claim 1, wherein
the resin molding apparatus includes:
a reservoir connected to the measuring-holding unit and configured to melt and store the resin material to be measured by the measuring-holding unit; and
a supply unit configured to supply the resin material to the reservoir, and the method further comprises:
causing the supply unit to stop supplying the resin material to the reservoir at a time when the resin material stored in the reservoir and the resin material held by the measuring-holding unit are completely used by executing the molding step in the final one of the molding cycles.

3. The method for controlling the resin molding apparatus according to claim 1, the method further comprising:
controlling the operation of the resin molding apparatus such that the measuring-holding unit does not measure or hold the resin material in the final one of the molding cycles when the object to be molded is switched in an inactive period of the resin molding apparatus subsequent to execution of the final one of the molding cycles.

4. A resin molding apparatus, comprising:
a measuring-holding unit configured to measure molten resin material and hold a predetermined amount of the measured resin material;
a molding unit configured to use the predetermined amount of the resin material held by the measuring-holding unit to mold a resin portion onto an object to be molded, including a motor core; and
circuitry configured to:
cause the molding unit and the measuring-holding unit to repeatedly execute a molding cycle during which the molding unit molds the resin portion and the measuring-holding unit operates after molding of the resin portion is completed; and
prohibit the measuring-holding unit from measuring the resin material and holding the resin material in a final one of molding cycles that are executed repeatedly a predetermined number of times.
